(19) United States
(12) Patent Application Publication
(10) Pub. No.: US 2026/0323125 A1
(43) Pub. Date: Oct. 15, 2026

(54) METHOD FOR DISPLAYING CAPTURED CONTENT AND TERMINAL DEVICE

(71) Applicant: ARASHI VISION INC., Shenzhen (CN)

(72) Inventors: Yongjie HUANG, Shenzhen (CN); Chunhong DENG, Shenzhen (CN)

(73) Assignee: ARASHI VISION INC., Shenzhen (CN)

(21) Appl. No.: 19/466,596

(22) Filed: Feb. 2, 2026

Related U.S. Application Data
(63) Continuation of application No. PCT/CN2025/083060, filed on Mar. 18, 2025.

(51) Int. Cl. H04N 21/472

(52) U.S. Cl. CPC H04N 21/472

(57) ABSTRACT

The present disclosure provides a method for displaying captured content, a terminal device, and a non-transitory computer-readable storage medium. A view operation for a captured content may be received. In response to the view operation, at least one target region can be displayed. Each target region is configured to display content indication items related to a target content and simultaneously display an original content indication item of the target content and at least one recommended content indication item. The at least one recommended content indication item indicates one or more recommended media contents in the target content, and the original content indication item indicates an original media content of the target content.

### CROSS-REFERENCE TO RELATED APPLICATION

This application is a continuation of International Application No. PCT/CN2025/083060, filed on Mar. 18, 2024, the entire content of which is hereby incorporated by reference in its entirety.

### BACKGROUND

The present disclosure relates to the field of information display technology, and in particular, to a method for displaying captured content and a terminal device.

With the development of the Internet and multimedia technology, the display of captured content has become a way of information transmission. Captured content can be displayed on a terminal device. When displaying captured content through a terminal device, the first frame image of the captured content can be displayed to help the user identify the content of the captured content. However, this display method makes it difficult to help the user efficiently identify all captured content.

### SUMMARY

The present disclosure provides a method for displaying captured content and a terminal device.

According to a first aspect, the present disclosure provides a method for displaying captured content, including: receiving a view operation for a captured content; and in response to the view operation, displaying at least one target region, where each target region is configured to display content indication items related to a target content, and each target region simultaneously displays an original content indication item of a target content and at least one recommended content indication item. The recommended content indication item indicates the recommended media content in the target content, and the original content indication item indicates the original media content of the target content.

According to a second aspect, the present disclosure provides a control terminal, one or more processors configured to operate individually or collectively, and a memory in communication with the processors. The memory stores instructions executable by the processors, and the instructions, when executed by the processors, cause the processors to receive a view operation for a captured content, and in response to the view operation, display at least one target region, where each target region is configured to display content indication items related to a target content, and each target region simultaneously displays an original content indication item of a target content and at least one recommended content indication item. The recommended content indication item indicates recommended media content in the target content, and the original content indication item indicates original media content of the target content.

According to the implementations of the present disclosure, by receiving a view operation for a captured content and displaying a target region, where the target region is configured to display a target content and simultaneously displays the original media content and recommended media content of the target content, the user can quickly identify the content of the captured content without playing the content, thereby improving the identification efficiency of the captured content.

### BRIEF DESCRIPTION OF DRAWINGS

The drawings are used to better understand the present solution and do not constitute a limitation to the present disclosure. The drawings are as follows:

FIG. 1A schematically illustrates an application scenario diagram of the method for displaying captured content according to an implementation of the present disclosure.

FIG. 1B schematically illustrates an application scenario diagram of the method for displaying captured content according to another implementation of the present disclosure.

FIG. 2 schematically illustrates a flowchart of the method for displaying captured content according to an implementation of the present disclosure.

FIG. 3A schematically illustrates captured content displayed according to an implementation of the present disclosure.

FIG. 3B schematically illustrates captured content displayed according to another implementation of the present disclosure.

FIG. 3C schematically illustrates captured content displayed according to yet another implementation of the present disclosure.

FIG. 3D schematically illustrates captured content displayed according to yet another implementation of the present disclosure.

FIG. 3E schematically illustrates a schematic diagram of sliding the recommended content indication item according to an implementation of the present disclosure.

FIG. 3F schematically illustrates a schematic diagram after sliding the recommended content indication item in FIG. 3E.

FIG. 3G schematically illustrates a display of captured content with tag information according to an implementation of the present disclosure.

FIG. 3H schematically illustrates a display of captured content with tag information according to another implementation of the present disclosure.

FIG. 3I schematically illustrates a display of captured content with tag information according to yet another implementation of the present disclosure.

FIG. 3J schematically illustrates a schematic diagram of displaying captured content on a device according to an implementation of the present disclosure.

FIG. 4 schematically illustrates a block diagram of a control terminal according to an implementation of the present disclosure.

### DETAILED DESCRIPTION

To make the objectives, technical solutions, and advantages of the implementations of the present disclosure clearer, the following will provide a clear and complete description of the technical solutions in the implementations of the present disclosure with reference to the accompanying drawings in the implementations of the present disclosure. Obviously, the described implementations are part of the implementations of the present disclosure, but not all. Based on the described implementations of the present disclosure, all other implementations obtained by those of ordinary skill in the art without creative work fall within the scope of protection of the present disclosure. It should be noted that throughout the drawings, the same or similar reference numerals are used to indicate the same or similar elements. In the following description, some specific implementations are for illustrative purposes only and should not be construed as any limitation to the present disclosure, but merely as examples of the implementations of the present disclosure. Where conventional structures or configurations may cause confusion in understanding the present disclosure, they are omitted. It should be noted that the shapes and sizes of the components in the drawings do not reflect the actual size and proportion, but are only schematic representations of the content of the implementations of the present disclosure.

Unless otherwise defined, the technical terms or scientific terms used in the implementations of the present disclosure should have the meanings commonly understood by those skilled in the art. The terms “first,” “second,” and similar words used in the implementations of the present disclosure do not indicate any order, quantity, or importance, but are only used to distinguish different components.

In the display interface for a captured content of a terminal device, generally, the first frame image of the captured content is displayed, or the first frame image and the identification of the content are displayed, to help the user identify the content of the content. However, this display method is difficult to help the user efficiently identify related content, for example, aerial content and panoramic content.

The content of aerial content is generally sky and ground, and there may be multiple flights at the same location with different camera movements, which leads to the first frame images of different aerial contents looking exactly the same, making it difficult to distinguish between different aerial contents. The first frame image of the panoramic content is generally ultra-wide-angle, making it difficult to see the details of the image, and the first frame may not be the image the user is interested in. The user finds it difficult to remember and locate the content of panoramic content through the first frame image. It is worth noting that the types of content applicable to the present disclosure are not limited to aerial content or panoramic content; and other types of content with similar content identification problems can also be applied.

In view of this, the implementations of the present disclosure, by receiving a view operation for a captured content; and in response to the view operation, displaying at least one target region, where each target region is configured to display content indication items related to a target content, and each target region simultaneously displays an original content indication item of the target content and at least one recommended content indication item, the recommended content indication item indicating recommended media content in the target content, and the original content indication item indicating original media content of the target content, can help the user quickly identify the content of the content (for example, aerial content or panoramic content) without playing the related content (for example, aerial content or panoramic content), thereby improving the identification efficiency of the content (for example, aerial content or panoramic content).

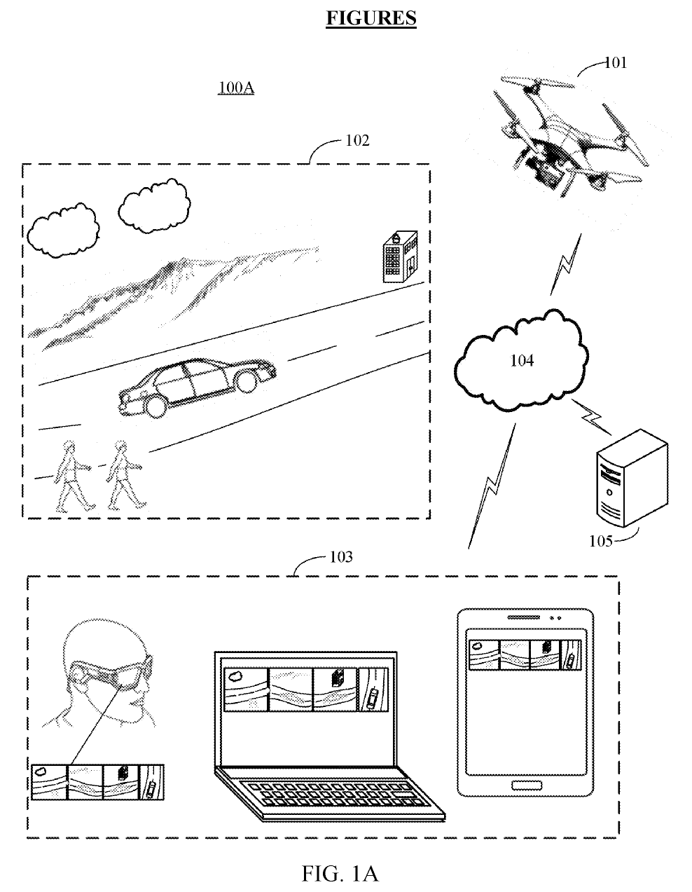

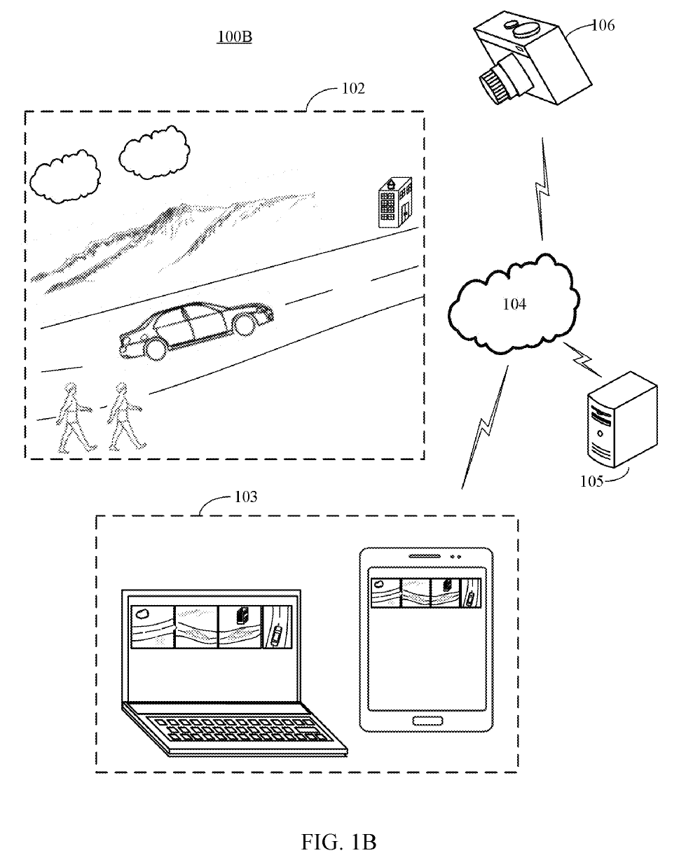

FIG. 1A schematically illustrates an application scenario diagram of the method for displaying captured content according to an implementation of the present disclosure.

As shown in FIG. 1A, in this exemplary architecture 100A, a panoramic Unmanned Aerial Vehicle (UAV) 101, a captured content 102, a terminal device 103, a network 104, and a server 105 may be included. The network 104 can be configured to provide a communication link between the panoramic UAV 101 and the server 105, between the panoramic UAV 101 and the terminal device 103, and between the terminal device 103 and the server 105. The network 104 can include various types of connections, such as wired, wireless communication links, or optical fiber cables, and so on.

A panoramic image capturing device can be configured on the panoramic UAV 101, which can be configured to capture content 102. The captured content 102 can be stored in a memory configured on the panoramic UAV 101, or can be sent to the server 105 for storage via the network 104. The terminal device 103 can obtain captured content from the panoramic UAV 101 or the server 105 through the network 104.

The terminal device 103 can be a terminal that interacts with the panoramic UAV 101 or the server 105. The interaction methods include but are not limited to triggering buttons, touch screens, or motion sensing actions. For example, it can be smart glasses, a mobile phone, a tablet computer, a remote controller with a screen, a camera (for example, a panoramic camera), a laptop computer, or a desktop computer, and so on.

FIG. 1B schematically illustrates an application scenario diagram of the method for displaying captured content according to another implementation of the present disclosure.

As shown in FIG. 1B, the difference between this exemplary architecture 100B and the exemplary architecture 100A shown in FIG. 1A is that the panoramic UAV 101 in 100A is replaced by a camera 106. The camera 106 can be, for example, a panoramic camera. In one example, the panoramic content can be captured by a panoramic camera, and the panoramic content captured by the panoramic camera can be viewed on a mobile terminal using an application of the panoramic camera. The mobile terminal can be, for example, a mobile phone, a computer, and so on.

The implementations of the present disclosure can be executed by the server 105. For example, the server 105 can be configured to receive a view operation for the captured content, and in response to the view operation, display at least one target region. Each target region is configured to display content indication items related to a target content, and each target region simultaneously displays an original content indication item of the target content and at least one recommended content indication item. The recommended content indication item indicates the recommended media content in the target content, and the original content indication item indicates the original media content of the target content.

The implementations of the present disclosure can also be executed by the terminal device 103. For example, the terminal device 103 can receive a view operation for the captured content, and in response to the view operation, display at least one target region. Each target region is configured to display content indication items related to a target content, and each target region simultaneously displays the original content indication item of the target content and the at least one recommended content indication item. The recommended content indication item indicates the recommended media content in the target content, and the original content indication item indicates the original media content of the target content.

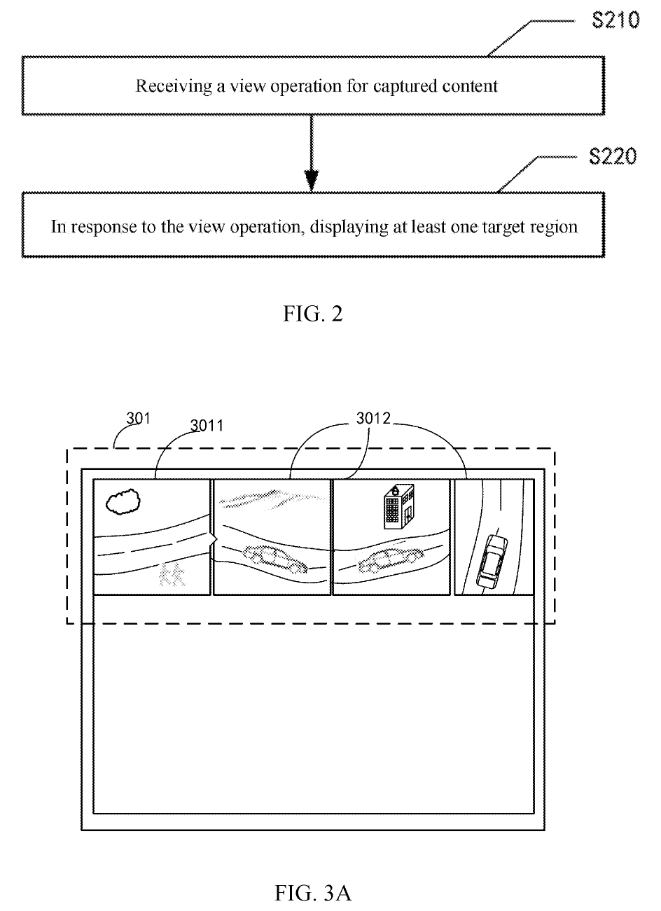

FIG. 2 schematically illustrates a flowchart of the method for displaying captured content according to an implementation of the present disclosure.

As shown in FIG. 2, the method can include operations S210 to S220.

In operation S210, a view operation can be received for the captured content.

In operation S220, in response to the view operation, at least one target region can be displayed. Each target region is configured to display content indication items related to a target content. Each target region simultaneously displays an original content indication item of the target content and at least one recommended content indication item. The recommended content indication item indicates a recommended media content in the target content, and the original content indication item indicates an original media content of the target content.

In some implementations, the captured content can be image or video data obtained by an image capturing device, such as a camera. As an example, the camera can be a panoramic camera, and correspondingly, the captured content can include the panoramic content. As another example, the camera can be set on a mobile device, and correspondingly, the captured content can include content captured by a mobile device, for example, aerial content.

In some implementations, the view operation can be triggered by a user or an intelligent robot, or can be an automated view operation triggered during the execution of some task according to the needs of the task. For example, a user can perform a touch operation on a mobile device with a display screen for the captured content, such as sliding, zooming, clicking, and so on, to view the captured content. Another example is that a user can perform a mouse wheel or keyboard shortcut operation on a desktop computer to view the captured content. Another example is that a user can perform a voice, gesture, or head movement operation on a wearable device, such as a smartwatch or smart glasses, to view the captured content. Another example is that a user can use a motion sensing remote controller to remotely click on the captured content on a screen that supports motion sensing operation or an interactive device, such as a display screen of flight glasses, a computer, or other terminal devices, to view the captured content.

In some implementations, the target region can be a region capable of displaying the content indication item of the target content. The target region can be a row displayed on the interface, or a column, and so on. In each target region, the original content indication item of the target content and the at least one recommended content indication item can be displayed simultaneously.

More specifically, in the description of the present disclosure, the term “target content” may refer to a completely captured content entity, such as a video, image sequence, or panoramic recording obtained by a capturing device. Each target content can serve as a basic object for display, recommendation, and analysis within the system. In the user interface, one target region may correspond to one target content, and the target content may include both original content and one or more recommended contents.

On the other hand, the term “original content” refers to a version of the target content captured by the device. It represents the original content data of the target content without segmentation, editing, or recommendation processing. In the display interface, the original content indication item is typically presented as a background or primary visual area to represent the entire captured scene. In some implementations, when the target content is a video clip, the original content indication item can be a thumbnail image of the first frame of the video clip. The term “recommended content” may refer to one or more highlight portions, key clips, or segments automatically or manually selected from the original content based on predefined criteria (such as camera movement, object recognition, or user preference). Each recommended content indication item can be displayed in a display region associated with the corresponding target content, and is configured to support operations such as sliding, browsing, or previewing within the target region.

In some implementations, the target content can be aerial content or panoramic content captured by a panoramic camera, or aerial content or panoramic content captured by a mobile device, for example, panoramic content captured by a mobile device with a panoramic camera function, or aerial content or panoramic content captured by a UAV device with a panoramic camera function. The target content can include one original content and multiple recommended content segments in the original content.

In some implementations, the original content indication item can indicate the original media content of the target content. For example, if the target content is an aerial video with a duration of 1 minute, the original content can be this 1-minute aerial video, and the original content indication item can be an image of this 1-minute aerial video, for example, the head-tracking image of the first frame of the video, or a user-defined image, and so on. In some implementations, the original content indication item can be presented as a thumbnail.

The recommended content indication item can indicate the recommended media content of the target content, which can be images from different views in the target media content, for example, each view can correspond to a different target object, and so on. It can also be the first frame image of a recommended content segment. It can also be a user-defined image of the recommended content segment. It can also be a highlight image recommended by an image recommendation algorithm, for example, the image containing the most target objects in a recommended content segment can be used as the recommended content indication item of the recommended content segment. Another example is that the clearest image in a recommended content segment can be used as the recommended content indication item of the recommended content segment. For example, if the target content is an aerial video with a duration of 1 minute, this 1-minute aerial video can be composed of 5 aerial video segments each with a duration of 20 seconds. These 5 aerial video segments can be used as recommended content, and the image of each 20-second aerial video segment can be used as the recommended content indication item. The 1-minute aerial video can have images of 5 aerial video segments, and the image can be the first frame image, or a highlight image recommended by an image recommendation algorithm, or a user-defined image. The number and duration of aerial video segments can be adjusted as needed. These aerial video segments can be highlight segments generated based on an image recommendation algorithm, or segments clipped by the user according to their own preferences. In some implementations, the recommended content indication item can be presented as a thumbnail.

In one example, the target content can be a segment of a car driving route captured by aerial photography. During this route, clouds, mountains, houses, and pedestrians appear with the car. The original content indication item can be the image at the beginning of the aerial photography, for example, only clouds and pedestrians. The first recommended content indication item can be the image when the car is driving along the mountain. The second recommended content segment can be the image of the car passing by the house. The third recommended content indication item can be the top-down image of a car driving.

According to the implementations of the present disclosure, by receiving a view operation for a captured content and displaying a target region, where the target region is configured to display a target content and simultaneously displays the original media content and recommended media content of the target content, the user can quickly identify the content of the captured content without playing the content, thereby improving the identification efficiency of the captured content.

In some implementations, the above-described target content can include at least one of the following: the content captured by a panoramic UAV, or the content captured by a mobile device. The panoramic UAV can be equipped with a panoramic camera, which can capture content by aerial photography, for example, using a follow shooting mode to follow a car, or using a surround mode or top-down mode to surround or top-down shoot the car, and so on. The mobile device, for example, a robot with an image capturing function, or a gimbal that can be used with an image capturing device, or a gimbal with an image capturing function, or other mobile devices, can capture panoramic content in a wide-angle mode, and so on.

The method for displaying captured content provided by the implementations of the present disclosure can be applied to, for example, aerial content and panoramic content. When displaying aerial content or panoramic content, only one aerial content or panoramic content is displayed in the target region, and the original content indication item and recommended content indication item of the aerial content or panoramic content are displayed in the target region, so that the user can quickly identify the content of the aerial content or panoramic content without playing the aerial content or panoramic content, thereby improving the identification efficiency of the aerial content or panoramic content.

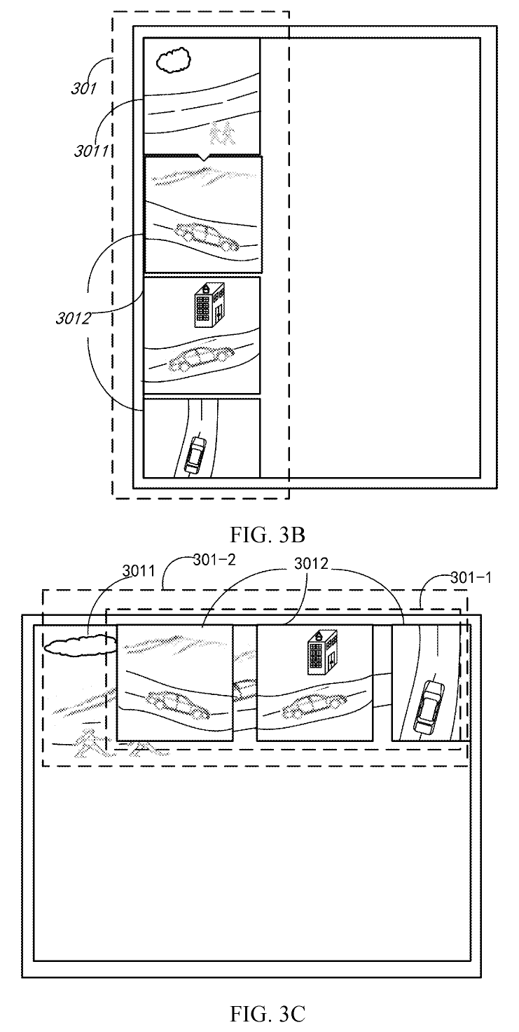

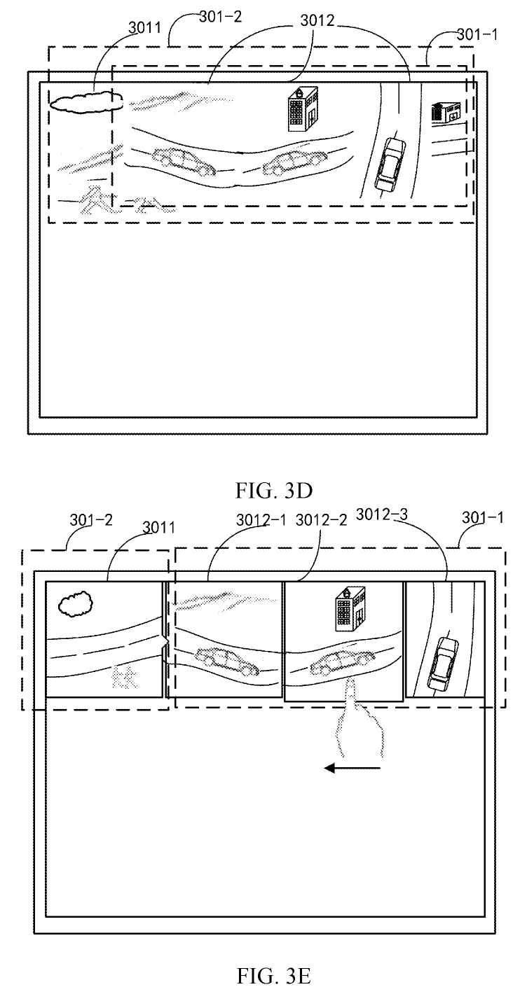

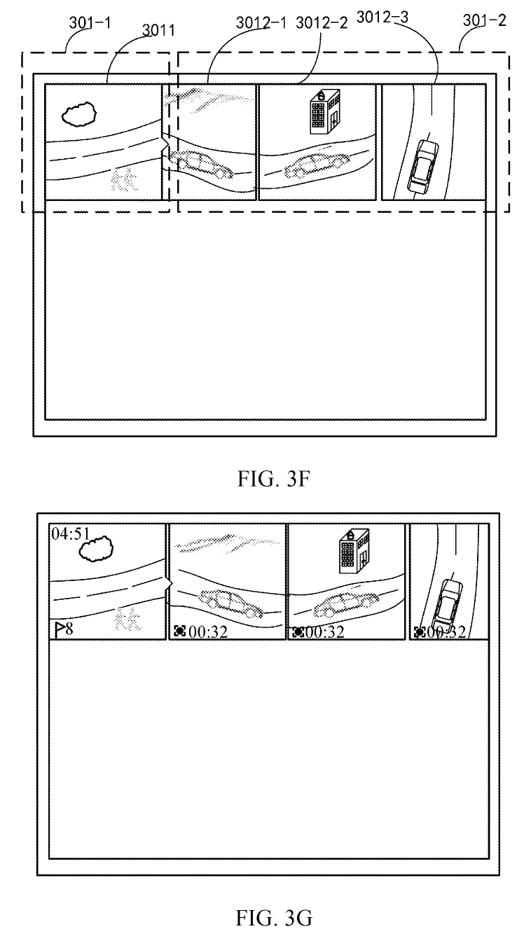

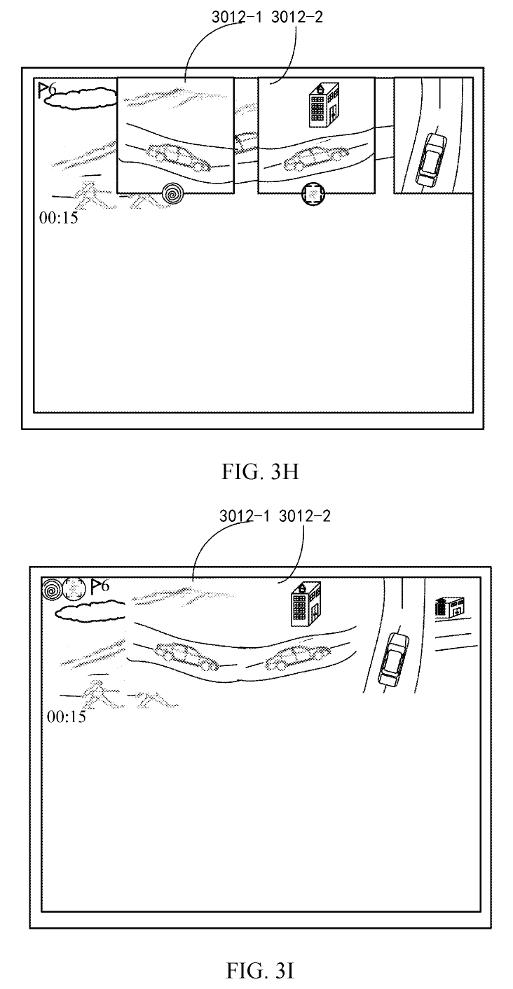

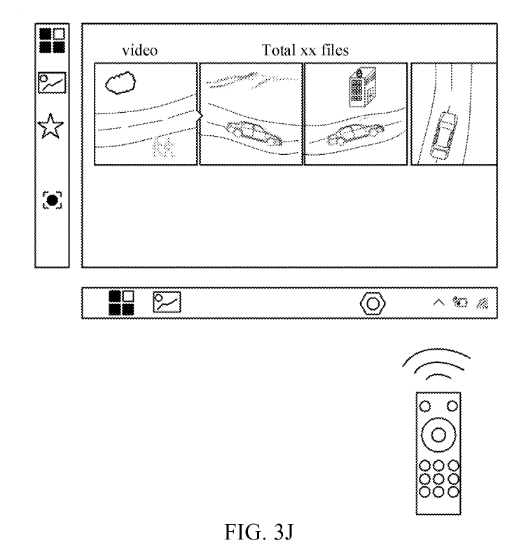

FIG. 3A schematically illustrates captured content displayed according to an implementation of the present disclosure. FIG. 3B schematically illustrates captured content displayed according to another implementation of the present disclosure.

In some implementations, the above operation S220 can include the following operation: in response to the view operation, displaying a content list, where the content list includes at least one target region.

Referring to FIG. 3A, the content list can be an album including multiple rows. The target region can be, as shown in FIG. 3A, a row of the display interface. In some implementations, the target region 301 can be, as shown in FIG. 3B, a column of the display interface, which can be adaptively adjusted as needed.

As shown in FIG. 3A, the target content can be displayed through a list of multiple rows (one row being shown in FIG. 3A). In this way, each row in the content list for displaying the target content can be a target region. Referring to FIG. 3B, the content list can also be an album including multiple columns (one column being shown in FIG. 3B), and the target content can be displayed through a list of multiple columns. In this way, each column in the content list for displaying the target content can be a target region.

Continuing to refer to FIGS. 3A or 3B, each target region 301 can be configured to display content indication items related to the target content. In the case of multiple content indication items related to target contents, different rows can be configured to display different contents related to the target contents, with each row displaying one content indication item related to a target content. Alternatively, different columns can be configured to display different content indication items related to target contents, with each column displaying one content indication item related to a target content.

According to the implementations of the present disclosure, by displaying a content list and displaying at least one target region on the content list, the original content indication item and recommended content indication item of the target content can be displayed on the target region, thereby helping the user quickly identify the content of the target content and improving the efficiency of content identification.

In some implementations, on the basis of the above operations, the method for displaying captured content according to the implementations of the present disclosure can further include the following operation: in response to a content display operation for the target region, displaying the original media content indicated by the original content indication item and/or the recommended media content indicated by the at least one recommended content indication item.

FIG. 3C schematically illustrates the captured content displayed according to yet another implementation of the present disclosure. FIG. 3D schematically illustrates the captured content displayed according to yet another implementation of the present disclosure.

Referring to FIGS. 3C and 3D, in some implementations, the target region can include a first display region 301-1 and a second display region 301-2. The first display region 301-1 is configured to display at least one recommended content indication item, and the second display region 301-2 can be configured to display an original content indication item. The display position of the second display region 301-2 in the target region can be fixed.

Referring to FIGS. 3A to 3D, in some implementations, the content display operation can be, for example, a play operation. For example, as shown in FIGS. 3A or 3B, by clicking the original content indication item 3011, such as an image, the original media content can be played. By clicking any recommended content indication item 3012, such as an image of a highlight segment, the recommended media content can be played. Another example is, as shown in FIGS. 3C or 3D, by clicking any position in the target region 3011, the original media content can be played. By clicking the recommended content indication item 3012, such as an image of a highlight segment, the recommended media content can be played.

According to the implementations of the present disclosure, after identifying the target content, by clicking the original content indication item or any position in the target region, the original media content can be played, or by clicking the recommended content indication item, the recommended media content can be played. This playback process can be performed upon efficiently and accurately identifying the target content. Since the above method for displaying captured content can efficiently and accurately identify the target content, it can avoid the problem of low efficiency in searching for content caused by the user needing to search for the content to be played multiple times due to not distinguishing the content, thereby improving the efficiency of content searching and the user experience.

In some implementations, the above-described original content indication item can include a picture corresponding to a first target view in the original media content. For example, the first target view can include a head-tracking view, which can be a view that is adjusted in real time according to head pose data, so that the view seen by the user is consistent with the user's head movement. The original content indication item can be the head-tracking image of the first frame of the video.

According to the implementations of the present disclosure, by displaying the picture of the first target view, for example, the picture of the head-tracking view, the user can quickly and intuitively identify the content of interest, reducing browsing time and improving the efficiency of browsing content.

In some implementations, the above-described recommended content indication item can include a picture corresponding to a target object in the recommended media content, and the target object can be displayed in a predetermined manner. For example, the predetermined manner can include at least one of the following: the display position is centered, a marking box is displayed, and the display brightness is greater than a predetermined threshold, and so on. The target object can be an element, region, or feature in the recommended media content. The target object can be determined by an image recommendation algorithm when generating highlight segments, or can be marked by the user.

In some implementations, at least one recommended content indication item, such as an image, can be a highlight segment in the target content. If the target object is locked in the highlight, the target object can be placed in the center of the recommended content indication item, for example, the center of the image. Another example is that a marking box can be configured for the target object, and the marking box can be displayed when displaying the target object. Another example is that the display brightness of the target object can be greater than a predetermined threshold, making it easier for the user to distinguish the target object from surrounding objects. The predetermined threshold can be adaptively adjusted as needed.

According to the implementations of the present disclosure, by displaying the target object in the recommended content in a predetermined manner, the user can quickly identify the target object in the recommended content, thereby improving the efficiency of identifying the target object in the recommended content.

In some implementations, the recommended media content can be determined based on a user mark, and the recommended content indication item can include a picture corresponding to a second target view in the recommended media content, where the second target view can include a view corresponding to the user mark.

In some implementations, when the user marks the recommended content, the highlight image can be determined based on the head-tracking view corresponding to the marking, and the recommended content indication item can be obtained. The user mark can be performed by clicking, box selection, annotation, and so on, to mark objects or regions in the content.

According to the implementations of the present disclosure, by marking the recommended content indication item by the user, personalized recommended content can be achieved, making it easier for the user to quickly identify the recommended content and improving the efficiency of identifying the recommended content.

In some implementations, there can be multiple recommended content indication items. The recommended content indication item in each target region can be arranged in a temporal order, where the temporal order represents a timing relationship of the recommended media content indicated by the recommended content indication item in the target content, or the temporal order represents a timing relationship of the recommended media content indicated by the recommended content indication item being marked by a user.

Referring to FIGS. 3A to FIG 3D , in some implementations, there can be multiple recommended content indication items 3012 (e.g., 3012-1, 3012-2, and 3012-3). Each recommended content indication item 3012 can be arranged according to the timing relationship of the recommended media content in the target content, for example, the order of appearance. It can also be arranged according to the timing relationship of the recommended media content being marked by the user, for example, the order of marking.

According to the implementations of the present disclosure, by arranging the recommended content in a temporal order, the user can view each recommended content in a coherent manner, improving the orderliness of the recommended content. In addition, arranging the recommended content in a temporal order also facilitates the user's search for recommended content.

In some implementations, there can be multiple recommended content indication items. The recommended content indication item in each target region can be arranged according to a recommendation priority, where the recommendation priority indicates a degree of user interest in the recommended media content indicated by the recommended content indication item.

In some implementations, the recommendation priority can be obtained based on the user's click collection operation or marking operation. For example, if the user clicks to collect a recommended content indication item, it can indicate that the user is interested in the recommended content indication item, and the recommendation priority of the recommended content indication item is higher than that of the recommended content indication item that has not been clicked to collect. Another example is that the user can mark the recommended content indication item of interest, for example, mark as interested, then the recommendation priority of the marked recommended content indication item is higher than that of the unmarked recommended content indication item.

In some implementations, the recommended content indication item with a user interest mark can be arranged before the recommended content indication item without a user interest mark, for example, arranged before the recommended content indication item recommended by the image algorithm. The image recommendation algorithm can not only generate the recommended content indication item, but also recommend the arrangement order of the recommended content indication item.

According to the implementations of the present disclosure, by marking the degree of user interest in the recommended content indication item, the user experience can be improved, and the efficiency and accuracy of generating personalized recommended content indication item can also be improved.

FIG. 3E schematically illustrates a schematic diagram of a sliding recommended content indication item according to an implementation of the present disclosure. FIG. 3F schematically illustrates a schematic diagram after sliding the recommended content indication item in FIG. 3E.

Continuing to refer to FIG. 3E and FIG. 3F, in some implementations, the target region can include a first display region 301-1, which is configured to display at least one recommended content indication item. On the basis of the above-disclosed operations, the method can further include the following operation: in response to an information update operation for the first display region, controlling the recommended content indication item of the target content to update a display position in the first display region according to a target movement trajectory corresponding to the information update operation. This sliding method can also be applied to the display method of captured content shown in FIG. 3C.

Referring to FIG. 3E, in some implementations, the information update operation can be a sliding operation. When there are many recommended content indication items, such as highlight segments, the user can slide to view more recommended content indication items. The target movement trajectory can be the sliding trajectory when the user slides the recommended content indication item.

In some implementations, the process of updating the display position can include the following operations: determining a sliding distance and sliding direction corresponding to the target sliding trajectory; and moving the recommended media content according to the sliding direction and sliding distance to update the display position of the target image in the first display region.

In one example, as shown in FIG. 3E, the sliding distance can be the sliding distance when the user clicks and holds the recommended content indication item to slide, and the sliding direction can be the sliding direction when the user clicks and holds the recommended content indication item to slide, for example, the left direction in the horizontal direction, as shown in FIG. 3E. The target image can be the recommended content indication item that the user wants to slide, for example, the second recommended content indication item 3012-2 that the user clicks and holds. The user can click and hold the second recommended content indication item 3012-2 and slide to the left.

In some implementations, based on the updated display positions of the recommended content indication item, the recommended content indication item to be displayed can be determined; and based on the updated display position of the recommended content indication item to be displayed, the recommended content indication item can be displayed in the target display region.

Referring to FIG. 3F, the display position of the second recommended content indication item 3012-2 after sliding in FIG. 3E is shown as the display position of the recommended content indication item to be displayed. Accordingly, the positions of the first recommended content indication item 3012-1 and the third recommended content indication item 3012-3 are also slid to the left. In another implementation, the user can click and hold multiple recommended content indication items and slide them to the left together.

According to the implementations of the present disclosure, the above sliding process can be as follows: the original content indication item can be fixed and not slidable, and the recommended content indication item can only slide in the first region. In this way, each row or each column can consistently provide an entry for identifying the original content indication item.

In some implementations, continuing to refer to FIG. 3C and FIG. 3D, the target region can include a second display region 301-2, which can be configured to display original content indication item. The display position of the second display region 301-2 in the target region can be fixed.

The second display region 301-2 can display an original content indication item, for example, the original image, the head-tracking image of the first frame of the target content, and so on. The second display region 301-2 can be used as the background of the first display region 301-1, that is, the original content indication item can be used as the background of the recommended content indication item.

According to the implementations of the present disclosure, by fixing the second display region, the position of the original content indication item is fixed, so that each row can consistently provide an entry for identifying the original content indication item or playing the original content indication item.

In some implementations, the first display region 301-1 can be displayed on the basis of the second display region 301-2, and a portion of the first display region 301-1 overlaps with a portion of the second display region 301-2. The recommended content indication item, such as a highlight image, can be displayed on the basis of the original content indication item, such as the original image, and the size occupied by the original content indication item, such as the original image, is larger than that occupied by the recommended content indication item, such as the highlight image.

Each recommended content indication item 3012 displayed in the first display region 301-1 can be arranged at a predetermined interval, as shown in FIG. 3C. The predetermined interval can be adaptively adjusted as needed, or can be arranged without an interval, as shown in FIG. 3D. The original content indication item can be displayed as the background of the first display region in the second display region. The difference between the display method in FIG. 3C and the display methods in FIGS. 3A or 3B is that in the display method shown in FIG. 3C, the original content indication item occupies an entire row, rather than only a portion of a row as in FIG. 3A, or only a portion of a column, as in FIG. 3B. The recommended content indication item in FIG. 3C can slide left and right. The recommended content indication item in FIG. 3D can be images of different highlight moments, or can be the first frame images of content segments evenly divided according to the duration of the target content.

According to the implementations of the present disclosure, compared with the display methods in FIGS. 3A or 3B, by displaying the first display region on the basis of the second display region, that is, displaying the recommended content indication item on the basis of the original content indication item, this display method can provide a larger display space for the recommended content indication item, allowing more content indication item to be displayed, so that the user can identify the captured content more easily and improve the efficiency of content identification. The implementations of the present disclosure also provide another sliding method for sliding the original content indication item or the recommended content indication item. Referring to FIGS. 3D to 3F, in some implementations, in response to an information update operation for the target region, controlling the content indication item of the target content to update a display position in the target region according to a target movement trajectory corresponding to the information update operation, where the content indication item includes the original content indication item and the recommended content indication item of the target content.

The difference between this sliding method and the previous sliding method is that in this sliding method, the original content indication item can slide in both the first display region and the second display region, and the recommended content indication item can also slide in both the first display region and the second display region.

According to the implementations of the present disclosure, this sliding method allows both the original content indication item and the recommended content indication item to be slidable, thereby improving the flexibility of interaction between the user and the original content indication item or the recommended content indication item.

FIG. 3G schematically illustrates a display of the captured content with tag information according to an implementation of the present disclosure. FIG. 3H schematically illustrates a display of the captured content with tag information according to another implementation of the present disclosure. FIG. 3I schematically illustrates a display of the captured content with tag information according to yet another implementation of the present disclosure.

In some implementations, the target region can also be configured to display tag information of the target content, where the tag information can include at least one of the following: quantity information of the recommended media content, type information of the recommended media content, a playback duration of the original media content, or a playback duration of the recommended media content.

In some implementations, as shown in FIG. 3G, the tag information in this implementation can include a playback duration of the original media content of 4 minutes and 51 seconds, a total of 8 recommended content indication items in the original media content, and the playback duration of each recommended media content can be 32 seconds. The type information of the recommended media content can be, for example, the type of camera movement during shooting, such as panoramic shooting, spiral camera movement, and tracking camera movement, and so on. Another example is shown in FIG. 3H, where the tag information in this implementation can include a total of 6 recommended content indication items in the original media content, and the playback duration of each recommended media content can be 15 seconds. Another example is shown in FIG. 3I, where the tag information in this implementation can include a total of 6 recommended content indication items in the original media content, and the playback duration of each recommended media content can be 15 seconds, and so on.

According to the implementations of the present disclosure, by displaying tag information of the target content, the user can quickly identify the content of the target content, thereby improving the efficiency of identifying the target content and the efficiency of browsing the target content.

In some implementations, the quantity information of the recommended media content can be displayed in a display region corresponding to the original content indication item, and the type information of the recommended media content can be displayed in a display region corresponding to the recommended content indication item or in a display region corresponding to the original content indication item.

In some implementations, as shown in FIG. 3G, the quantity information of 8 of the recommended content can be displayed on the original content indication item, and the type information of the recommended media content can be displayed on the recommended content indication item. As shown in FIG. 3H, the quantity information 6 and the duration 00:15 of the recommended content can both be displayed on the original content indication item, and the type information of the recommended media content, such as spiral camera movement or tracking camera movement, can be displayed on the recommended content indication item. As shown in FIG. 3I, the quantity information 6, and the duration 00:15 of the recommended content, as well as the type information of the recommended media content, can all be displayed on the original content indication item. According to the implementations of the present disclosure, by displaying the quantity information of the recommended media content in the display region corresponding to the original content indication item, and displaying the type information of the recommended media content in the display region corresponding to the recommended content indication item or the original content indication item, the user can quickly locate the required information, and the display region of the information is clear, which can improve the user's understanding of the media content.

In some implementations, the type information of the recommended media content can include at least one of the following: a type of camera movement corresponding to the time of capturing the recommended media content, a capturing mode corresponding to the time of capturing the recommended media content, or a type of user mark of the recommended media content.

In some implementations, as shown in FIG. 3H, the camera movement of the content of the first recommended content indication item 3012-1 in this implementation can be spiral camera movement, and the camera movement of the content of the second recommended content indication item 3012-2 can be tracking camera movement, and so on. The camera movement in this implementation can be displayed in the display region corresponding to the recommended content indication item, for example, displayed on the recommended content indication item. Another example is shown in FIG. 3I, where the camera movement of the content of the first recommended content indication item 3012-1 in this implementation can be spiral camera movement, and the camera movement of the content of the second recommended content indication item 3012-2 can be tracking camera movement, and so on. These camera movements in this implementation can all be displayed in the display region corresponding to the original content indication item, for example, displayed on the original content indication item.

According to the implementations of the present disclosure, by displaying the type of camera movement corresponding to the time of capturing the recommended media content, the capturing mode corresponding to the time of capturing the recommended media content, and the type of user mark of the recommended media content, multi-dimensional type information can be provided, making it easier for the user to browse and make decisions, and improving the efficiency of identifying and browsing the content.

FIG. 3J schematically illustrates a schematic diagram of displaying captured content on a device according to an implementation of the present disclosure.

The method for displaying captured content according to the implementations of the present disclosure can be applied to display devices such as smart glasses, mobile phones, computers, motion sensing remote controllers with a display module, gimbals with a display module, and so on. In one example, the captured content displayed on the display device can be as shown in FIG. 3J. In this implementation, the user can interact with the target content using the ray of the motion sensing remote controller.

The method for displaying captured content provided by the implementations of the present disclosure can help the user quickly identify the content of the content without playing the content.

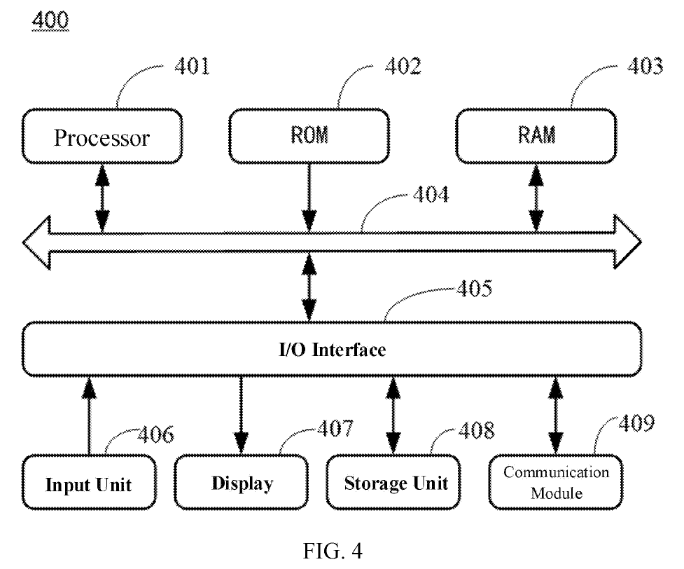

FIG. 4 schematically illustrates a block diagram of a control terminal according to an implementation of the present disclosure.

FIG. 4 shows a schematic block diagram of an exemplary control terminal 400 that can be configured to implement the implementations of the present disclosure. For example, a motion-sensing remote controller. The components, their connections and relationships, and their functions shown herein are merely examples and are not intended to limit the implementations of the present disclosure described and/or claimed herein.

As shown in FIG. 4, the control terminal 400 includes a processor 401, which can include one or more, and can work individually or collectively. It can perform various appropriate actions and processing according to a computer program stored in a read-only memory (ROM) 402 or a computer program loaded from a storage unit 408 into a random access memory (RAM) 403. For example, the memory can store instructions executable by the processor, and the instructions are executed by the processor to cause the processor to receive a view operation for a captured content, and in response to the view operation, display at least one target region, where each target region is configured to display content indication items related to a target content, and each target region simultaneously displays original content indication item of a target content and at least one recommended content indication item. The recommended content indication item indicates recommended media content in the target content, and the original content indication item indicates original media content of the target content.

Various programs and data required for the operation of the control terminal 400 can also be stored in the RAM 403. The processor 401, ROM 402, and RAM 403 are connected to each other via a bus 404. The input/output (I/O) interface 405 is also connected to the bus 404.

Multiple components in the control terminal 400 are connected to the I/O interface 405, including: an input unit 406, such as a keyboard, mouse, and so on; a display 407, for example, which can be configured to display a visual interface; a storage unit 408, such as a disk, optical disk, and so on; and a communication module 409, such as a network card, modem, wireless communication transceiver, and so on. The communication module 409 allows the control terminal 400 to exchange information/data with other devices through a computer network such as the Internet and/or various telecommunication networks.

The processor 401 can be various general-purpose and/or special-purpose processing components with processing and computing capabilities. Some examples of the processor 401 include, but are not limited to, a central processing unit (CPU), a graphics processing unit (GPU), various dedicated artificial intelligence (AI) computing chips, various processors running machine learning model algorithms, a digital signal processor (DSP), and any suitable processor, controller, microcontroller, and so on. The processor 401 executes the various methods and processing described above, for example, a target tracking method based on a panoramic UAV. For example, in some implementations, the target tracking method based on a panoramic UAV can be implemented as a computer software program, which is tangibly contained in a machine-readable medium, such as the storage unit 408. In some implementations, part or all of the computer program can be loaded and/or installed onto the control terminal 400 via the ROM 402 and/or the communication module 409. When the computer program is loaded into the RAM 403 and executed by the processor 401, one or more operations of the target tracking method based on a panoramic UAV described above can be performed. In some implementations, in other implementations, the processor 401 can be configured to perform the target tracking method based on a panoramic UAV in any other suitable way, for example, by means of firmware.

According to the implementations of the present disclosure, the processor is further configured to: in response to the view operation, display a content list, where the content list includes at least one target region.

According to the implementations of the present disclosure, the processor is further configured to: in response to a content display operation for the target region, display the original media content indicated by the original content indication item and/or the recommended media content indicated by the at least one recommended content indication item.

According to the implementations of the present disclosure, the target content includes at least one of the following: content captured by a panoramic UAV, or content captured by a mobile device.

According to the implementations of the present disclosure, the original content indication item includes a picture corresponding to a first target view in the original media content.

According to the implementations of the present disclosure, the recommended content indication item includes a picture corresponding to a target object in the recommended media content, and the target object is displayed in a predetermined manner.

According to the implementations of the present disclosure, the recommended media content is determined based on a user mark, and the recommended content indication item includes a picture corresponding to a second target view in the recommended media content, where the second target view includes a view corresponding to the user mark.

According to the implementations of the present disclosure, there are multiple recommended content indication items. The recommended content indication item in each target region is arranged in a temporal order, where the temporal order represents a timing relationship of the recommended media content indicated by the recommended content indication item in the target content, or the temporal order represents a timing relationship of the recommended media content indicated by the recommended content indication item being marked by a user.

According to the implementations of the present disclosure, there are multiple recommended content indication items. The recommended content indication item in each target region is arranged according to a recommendation priority, where the recommendation priority indicates a degree of user interest in the recommended media content indicated by the recommended content indication item.

According to the implementations of the present disclosure, the target region includes a first display region, and the first display region is configured to display at least one recommended content indication item. The method further includes: in response to an information update operation for the first display region, controlling the recommended content indication item of the target content to update a display position in the first display region according to a target movement trajectory corresponding to the information update operation.

According to the implementations of the present disclosure, the target region further includes a second display region, the second display region is configured to display an original content indication item, and the second display region has a fixed display position in the target region.

According to the implementations of the present disclosure, the first display region is displayed on a basis of the second display region, and a portion of the first display region overlaps with a portion of the second display region.

According to the implementations of the present disclosure, the processor is configured to: in response to an information update operation for the target region, control the content indication item of the target content to update a display position in the target region according to a target movement trajectory corresponding to the information update operation, where the content indication item includes the original content indication item and the recommended content indication item of the target content.

According to the implementations of the present disclosure, the target region is further configured to display tag information of the target content, where the tag information includes at least one of the following: quantity information of the recommended media content, type information of the recommended media content, a playback duration of the original media content, or a playback duration of the recommended media content.

According to the implementations of the present disclosure, the quantity information of the recommended media content is displayed in a display region corresponding to the original content indication item, and the type information of the recommended media content is displayed in a display region corresponding to the recommended content indication item.

According to the implementations of the present disclosure, the type information of the recommended media content includes at least one of the following: a type of camera movement corresponding to the time of capturing the recommended media content, a capturing mode corresponding to the time of capturing the recommended media content, or a type of user mark of the recommended media content.

In some embodiments, the present disclosure provides a non-transitory computer-readable storage medium storing executable instructions that, when executed by one or more processors configured to operate individually or collectively, cause the one or more processors to perform operations for managing and presenting captured content. The operations include receiving a view operation associated with the captured content and, in response, displaying at least one target region in a user interface. Each target region can be configured to display content indication items related to a target content and to simultaneously display an original content indication item corresponding to an original media content of the target content, together with at least one recommended content indication item corresponding to one or more recommended media contents associated with the target content. Through this configuration, the storage medium enables interactive presentation of related media contents, thereby enhancing user engagement.

It should be understood that the various forms of processes shown above can be reordered, added, or deleted. For example, the operations described in the present disclosure can be performed in parallel, sequentially, or in a different order, as long as the desired results of the technical solutions disclosed in the present disclosure can be achieved, and the present disclosure does not limit this.

The above specific implementations do not constitute a limitation to the scope of protection of the present disclosure. Those skilled in the art should understand that various modifications, combinations, sub-combinations, and substitutions can be made according to design requirements and other factors. Any modifications, equivalent substitutions, and improvements made within the spirit and principles of the present disclosure should be included within the scope of protection of the present disclosure.

What is claimed is:

1. A method for displaying captured content, comprising:
receiving a view operation for a captured content; and
in response to the view operation, displaying at least one target region,
wherein:
each target region is configured to:
display content indication items related to a target content; and
simultaneously display (i) an original content indication item indicating an original media content of the target content; and (ii) at least one recommended content indication item indicating one or more recommended media contents in the target content.

2. The method according to claim 1, wherein displaying the at least one target region in response to the view operation comprises:
in response to the view operation, displaying a content list, wherein the content list comprises the at least one target region.

3. The method according to claim 1, further comprising:
in response to a content display operation for the target region, displaying at least one of:
the original media content indicated by the original content indication item, or
the one or more recommended media contents indicated by the at least one recommended content indication item.

4. The method according to claim 1, wherein the target content comprises at least one of:
a content captured by a panoramic Unmanned Aerial Vehicle (UAV), or
a content captured by a mobile device.

5. The method according to claim 4, wherein the original content indication item comprises a picture corresponding to a first target view in the original media content.

6. The method according to claim 4, wherein the at least one recommended content indication item comprises a picture corresponding to a target object in the one or more recommended media contents, and the target object is displayed in a predetermined manner.

7. The method according to claim 4, wherein the one or more recommended media contents are determined based on a user mark, and the at least one recommended content indication item comprises a picture corresponding to a second target view in the one or more recommended media contents, the second target view comprising a view corresponding to the user mark.

8. The method according to claim 1, wherein:
the at least one recommended content indication item comprises multiple recommended content indication items, and the one or more recommended media contents comprise multiple recommended media contents;
the multiple recommended content indication items in each target region are arranged according to a recommendation priority, the recommendation priority indicating a degree of user interest in the multiple recommended media contents indicated by the multiple recommended content indication items;
the target region comprises a first display region configured to display the multiple recommended content indication items; and
the method further comprises:
in response to an information update operation for the first display region, controlling the multiple recommended content indication items of the target content to update a display position in the first display region according to a target movement trajectory corresponding to the information update operation.

9. The method according to claim 8, wherein the target region further comprises a second display region configured to display the original content indication item, and the second display region has a fixed display position in the target region.

10. The method according to claim 9, wherein the first display region is displayed on a basis of the second display region, and a portion of the first display region overlaps with a portion of the second display region.

11. The method according to claim 1, further comprising:
in response to an information update operation for the target region, controlling the content indication items of the target content to update a display position in the target region according to a target movement trajectory corresponding to the information update operation, wherein the content indication items comprise the original content indication item and the at least one recommended content indication item of the target content.

12. The method according to claim 1, wherein the target region is further configured to display tag information of the target content, the tag information comprising at least one of:
quantity information of the one or more recommended media contents;
type information of the one or more recommended media contents;
a playback duration of the original media content; or
a playback duration of the one or more recommended media contents.

13. The method according to claim 12, wherein the quantity information of the one or more recommended media contents is displayed in a display region corresponding to the original content indication information, and the type information of the one or more recommended media contents is displayed in a display region corresponding to the recommended content indication information.

14. The method according to claim 12, wherein the type information of the one or more recommended media contents comprises at least one of the following:
a type of camera movement corresponding to a time of capturing the one or more recommended media contents, a capturing mode corresponding to the time of capturing the one or more recommended media contents, or a type of user mark of the one or more recommended media contents.

15. A control terminal, comprising:
one or more processors configured to operate individually or collectively; and
a memory coupled with the one or more processors and configured to store executable instructions,
wherein the executable instructions, when executed by the one or more processors, cause the one or more processors to receive a view operation for a captured content, and in response to the view operation, display at least one target region, wherein:
each target region is configured to:
display content indication items related to a target content; and
simultaneously display (i) an original content indication item of the target content indicating an original media content of the target content; and (ii) at least one recommended content indication item indicating one or more recommended media contents in the target content.

16. The control terminal according to claim 15, wherein the one or more processors are further configured to:
in response to the view operation, display a content list, wherein the content list comprises the at least one target region.

17. The control terminal according to claim 15, wherein the one or more processors are further configured to in response to a content display operation for the target region, display at least one of:
the original media content indicated by the original content indication item; or
the one or more recommended media contents indicated by the at least one recommended content indication item.

18. The control terminal according to claim 15, wherein the target content comprises at least one:
a content captured by a panoramic Unmanned Aerial Vehicle (UAV); or
a content captured by a mobile device.

19. The control terminal according to claim 15, wherein:
the at least one recommended content indication item comprises multiple recommended content indication items, and the one or more recommended media contents comprise multiple recommended media contents; and
the multiple recommended content indication items in each target region are arranged in a temporal order, the temporal order representing a timing relationship of the multiple recommended media contents indicated by the multiple recommended content indication items in the target content, or the temporal order representing a timing relationship of the multiple recommended media contents indicated by the multiple recommended content indication items being marked by a user.

20. A non-transitory computer-readable storage medium storing executable instructions which, when executed by one or more processors configured to operate individually or collectively, cause the one or more processors to:
receive a view operation for a captured content; and
in response to the view operation, display at least one target region, wherein each target region is configured to:
display content indication items related to a target content; and
simultaneously display (i) an original content indication item of the target content indicating an original media content of the target content; and (ii) at least one recommended content indication item indicating one or more recommended media contents in the target content.
